(19) United States
(12) Patent Application Publication
(10) Pub. No.: US 2018/0021856 A1
(43) Pub. Date: Jan. 25, 2018

(54) HETEROGENEOUS POWDER MOLDED BODY AND MANUFACTURING METHOD THEREOF

(71) Applicant: Hyundai Motor Company, Seoul (KR)

(72) Inventors: Jin-Hyeon LEE, Busan (KR); Yeong-Cheol JO, Suwon-si (KR); Hyung-Seok KWAK, Gunpo-si (KR)

(73) Assignee: Hyundai Motor Company, Seoul (KR)

(21) Appl. No.: 15/365,791

(22) Filed: Nov. 30, 2016

(30) Foreign Application Priority Data
Jul. 20, 2016 (KR) 10-2016-0091858

(51) Int. Cl. B22F 7/06; B22F 7/00; F16D 23/02; B22F 3/04

(52) U.S. Cl. CPC B22F 7/06; B22F 3/04; B22F 7/008; F16D 23/02; B22F 2998/10; B22F 2301/35; B22F 2301/10; F16D 2200/0008; F16D 2200/0086

(57) ABSTRACT

A heterogeneous powder molded body may include respective powder processed parts formed of different powders, the heterogeneous powder molded body being formed by a forming machine including a die, a lower forming module located under the die to form a lower part of a molded body to be manufactured, and an upper forming module located above the die to form an upper part of the molded body to be manufactured, in which when each of the different powders is input onto the die to form the molded body, the die ascends and thus a filling time of each input powder is secured.

### CROSS-REFERENCE TO RELATED APPLICATION

The present application claims priority to Korean Patent Application No. 10-2016-0091858, filed Jul. 20, 2016, the entire contents of which is incorporated herein for all purposes by this reference.

### BACKGROUND OF THE INVENTION

### Field of the Invention

The present invention relates to a heterogeneous powder molded body and a manufacturing method thereof, and more particularly, to a heterogeneous powder molded body in which parts requiring specific strength are formed by inputting powder of a material having the corresponding strength, and a manufacturing method thereof.

### Description of Related Art

In general, if a molded body is formed using powder, in order to form a specific part of the molded body having a high strength or to increase friction ability of a specific part of the molded body, a method in which only the specific part is heat-treated using a high frequency or a method in which the overall molded body is formed using high alloy powder is used.

However, such a heat treatment method or a method using high alloy powder may lower processability, increase manufacturing costs and degrade the quality of a molded body product due to heat treatment.

Further, if a molded body is formed using different kinds of powders, a density gradient of the molded body may occur.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a heterogeneous powder molded body and a manufacturing method thereof, in which, if a product is formed using different kinds of powders, the product may have no density gradient and good processability, reduce manufacturing costs and undergo no quality degradation owing to omission of conventional heat treatment.

According to various aspects of the present invention, a heterogeneous powder molded body may include respective powder processed parts formed of different powders, the heterogeneous powder molded body being formed by a forming machine including a die, a lower forming module located under the die so as to form a lower part of a molded body to be manufactured, and an upper forming module located above the die so as to form an upper part of the molded body to be manufactured, in which when each of the different powders is input onto the die so as to form the molded body, the die may ascend and thus a filling time of each input powder may be secured.

A filling ratio of the respective powders may be adjusted to set strength and hardness of the respective powder processed parts to required degrees.

An ascending speed of the die may be adjustable according to a required degree of uniformity of an interface between the respective powder processed parts.

Ascending and descending speeds of the lower forming module and the upper forming module may be adjustable.

Speeds at which powder suppliers of the respective powders are transferred to and separated from the die may be adjustable.

A manufacturing method of a heterogeneous powder molded body, formed of a first powder and a second powder, by a forming machine, having a die, a lower forming module located under the die to form a lower part of a molded body to be manufactured, and an upper forming module located above the die to form an upper part of the molded body to be manufactured, may include inputting the first powder from a first powder supply placed on the die to form a first powder processed part, inputting the second powder from a second powder supply placed on the die to form a second powder processed part, pressurizing the upper forming module in a downward direction to form an upper shape of the molded body formed of the first powder and the second powder, and completing manufacture of the molded body by separating the upper forming module and the second forming module from the molded body.

The manufacturing method according may further include, after the input of the second powder, re-inputting the first powder from the first powder supply again placed on the die to form another first powder processed part.

When each of the different powders is input onto the die to form the molded body, the die ascends and thus a filling time of the input powder is secured.

A filling ratio of the respective powders may be adjusted to set strength and hardness of the respective powder processed parts to required degrees.

An ascending speed of the die may be adjusted.

Ascending and descending speeds of the lower forming module and the upper forming module may be adjusted.

Speeds at which the powder supplies of the respective powders are transferred to and separated from the die may be adjusted.

A sintered body formed of different kinds of powders, manufactured by a forming machine including a die, a lower forming module located under the die to form a lower part of a molded body to be manufactured, and an upper forming module located above the die to form an upper part of the molded body to be manufactured, may include first powder processed parts formed by inputting a first powder from a first powder supply placed on the die, and a second powder processed part formed by inputting second powder from a second powder supply placed on the die, in which a lower shape of the sintered body may be formed by the lower forming module, and an upper shape of the sintered body may be formed by pressurizing the upper forming module in the downward direction.

The first powder processing parts may be formed of mixture powder, and the second powder processing part may be formed of alloy powder.

The mixture powder used to form the first powder processing parts may include Fe—Cu—C mixture powder, and the alloy powder used to form the second powder processing part may include Fe—Cr—Mo—C alloy powder.

The sintered body may be used as a synchronizer hub for vehicles.

The first powder processed parts may be formed in a core area of a center of the synchronizer hub, and the second powder processed part may be formed in a remaining area of the synchronizer hub other than the core area.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1(a), (b), (c), (d), and (e) are views exemplarily showing a manufacturing process of a heterogeneous powder molded body in accordance with various embodiments of the present invention.

FIG. 2 is a view showing the configuration of a heterogeneous powder molded body, formed by a manufacturing method of a heterogeneous powder molded body in accordance with various embodiments of the present invention.

FIG. 3 is a micrograph of an interface of a heterogeneous powder molded body in accordance with various embodiment of the present invention.

FIG. 4 is a view illustrating the operating state of a die of a forming machine used in the manufacturing method in accordance with various embodiments of the present invention.

FIG. 5 is a view illustrating a synchronizer hub for vehicles, manufactured in accordance with the manufacturing method according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

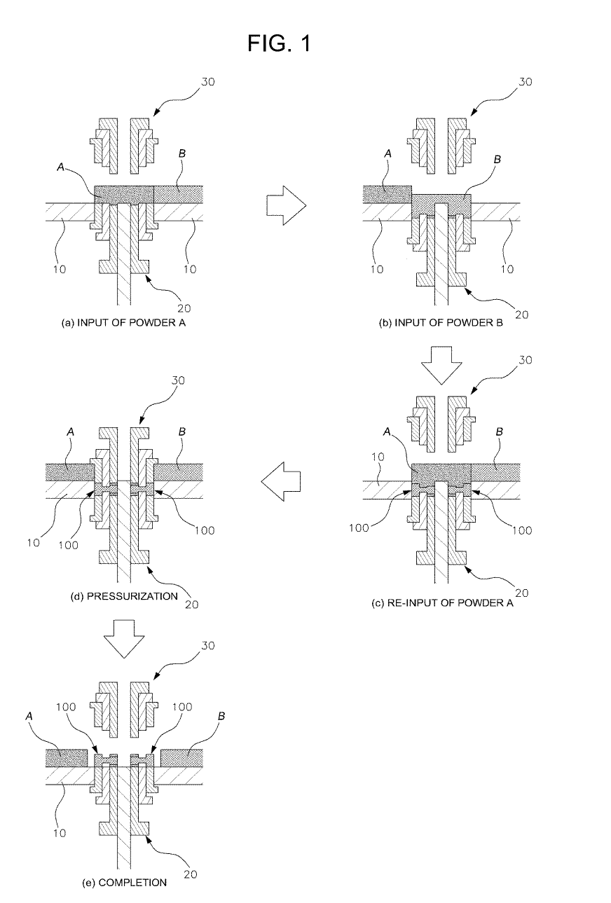

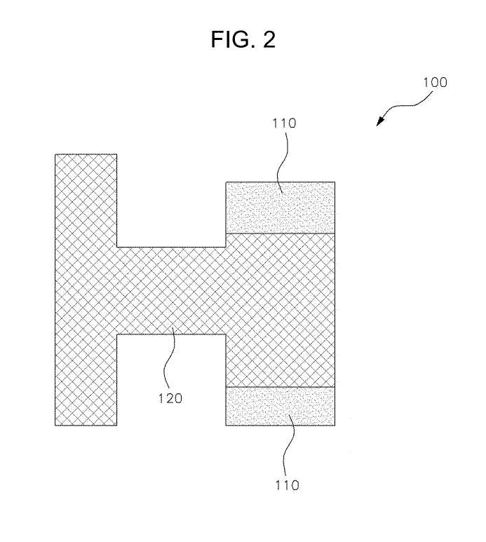

FIGS. 1(a) to 1(e) are views exemplarily showing a manufacturing process of a heterogeneous powder molded body in accordance with various embodiments of the present invention, and FIG. 2 is a view showing the configuration of a heterogeneous powder molded body in accordance with various embodiments of the present invention.

With reference to FIGS. 1(a) to 2, a heterogeneous powder molded body in accordance with various embodiments of the present invention is a sintered body formed using different kinds of powders, in which parts requiring a specific strength are formed by inputting powder of a material having the corresponding strength.

Therefore, the specific parts of the molded body may have hardness and strength of required degrees according to characteristics of the material of the input powder.

For this purpose, as exemplarily shown in FIGS. 1(a) to 1(e), the heterogeneous powder molded body of various embodiments of the present invention is manufactured by a forming machine including a lower forming module 20 located under a die 10 so as to form a lower part of a molded body to be manufactured, and an upper forming module 30 located above the die 10 so as to form an upper part of the molded body to be manufactured, and a manufacturing method of the heterogeneous powder molded body will be sequentially described below.

As one example of the forming machine, a known multi-stage punch device, which punches a product having staircase parts so as to reduce a density gradient of a molded body, may be used and the manufacturing method in accordance with the present invention may be carried out by precisely controlling the multi-stage punch device.

### Input of Powder A

The molded body of various embodiments of the present invention is a molded body 100 formed by inputting different kinds of powders, and a lower shape of the molded body 100 is formed by the lower forming module 20.

Further, a powder supplier A is placed on a molded body formation area of the die 10 and then inputs powder A. A powder A processed part 110 of the molded body 100 is formed using the input powder A.

After input of the powder A, the powder supplier A is separated from the molded body formation area.

### Input of Powder B

Subsequent to input of the powder A, the lower forming module 20 continues to execute formation of the lower shape of the molded body 100, thus completing formation of the lower shape of the molded body 100.

Thereafter, a powder supplier B is placed on the molded body formation area of the die 10 and then inputs powder B. A powder B processed part 120 of the molded body 100 is formed using the input powder B.

After input of the powder B, the powder supplier B is separated from the molded body formation area.

### Re-Input of Powder A

The powder supplier A is again placed on the molded body formation area of the die 10 and then inputs the powder A. Another powder A processed part 110 of the molded body 100 is formed using the re-input powder A.

After input of the powder A, the powder supplier A is separated from the molded body formation area.

### Pressurization

The upper forming module 30 located above the molded body formation area of the die 10 is pressurized in the downward direction and thus forms an upper shape of the molded body 100 formed of different kinds of powders, i.e., the powder A and the powder B.

### Completion of Manufacture of Molded Body

When formation of the upper shape of the molded body 100 by the upper forming module 30 through pressurization is completed, the upper forming module 30 and the lower forming module 20 are separated from the molded body 100, thus completing manufacture of the molded body 100.

Therefore, through the above-described manufacturing method in accordance with various embodiments of the present invention, as exemplarily shown in FIG. 2, the molded body 100, including a main part which is the powder B processed part 120 formed of the powder B, and two specific parts which are the powder A processed parts 110 formed of the powder A, is formed.

Further, bonding of different materials, i.e., the powder A processed part 110 and the powder B processed part 120, at the interface is carried out based on the principle of carbon diffusion. Carbon diffusion refers to a principle in which, in order to remove a concentration difference between two materials, carbon atoms having a small atomic size move between grids of the different materials by diffusion of interstitial atoms and thus the interface between the materials is changed from an non-equilibrium state to an equilibrium state so as to generate bonding force between the different materials at the interface.

A filling ratio of the powder A to the powder B may be adjusted according to the required degrees of strength and hardness of the powder A processed parts 110 and the powder B processed part 120. Further, by adjusting the filling ratio of the powder A to the powder B, the interface between the respective powders may be clearly secured and mixing of the powders may be minimized.

As an example of the filling ratio of the powder A to the powder B in accordance with various embodiments of the present invention, if the powder A is a mixture powder (SMF4040M) and the powder B is an alloy powder (CrM) and a filling ratio of the powder A (SMF4040M) to the powder B (CrM) is 5.2:5.5, a density difference between the parts formed of the powder A and the part formed of the powder B is very small, i.e., just 0-0.04 and thus a density gradient between the different powders may be solved.

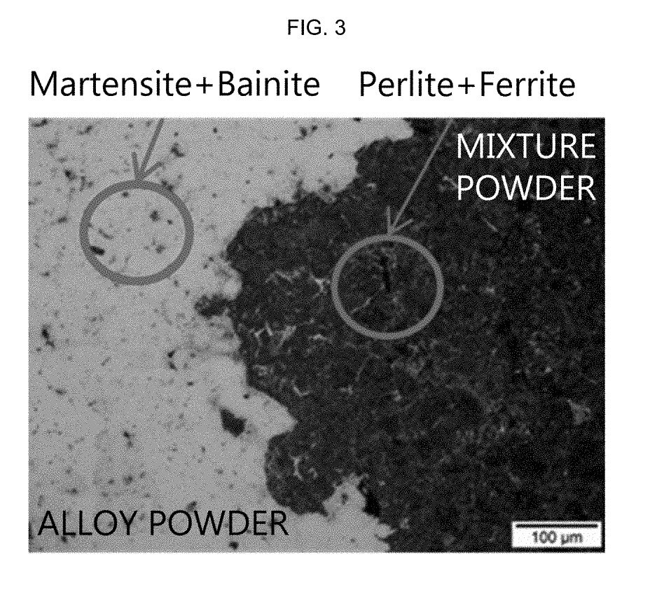

FIG. 3 is a micrograph of an interface between respective processed part of a heterogeneous powder molded body in accordance with various embodiments of the present invention, in which powder A processed parts 110 are formed of Fe—Cu—C mixture powder and a powder B processed part 120 is formed of Fe—Cr—Mo—C alloy powder. Here, a difference of structures occurs due to a difference of hardenability between the mixture powder and the alloy powder during sintering. The micrograph of FIG. 3 shows that perlite and ferrite structures are mixed in a mixture powder area and martensite and bainite structures are mixed in an alloy powder area.

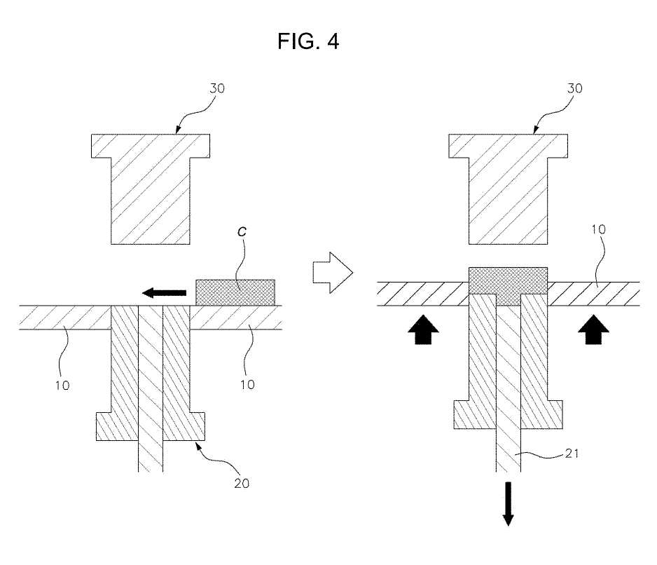

FIG. 4 is a view illustrating the operating state of a die of a forming machine used in the manufacturing method in accordance with various embodiments of the present invention. If a powder supplier C is placed on a molded body formation area of a die 10 and then inputs powder during the manufacturing method of the molded body in accordance with various embodiments of the present invention, section filling in which the entirety of the die 10 ascends is carried out so as to secure a filling time of the input powder and, thus, a uniform interface between different kinds of powders may be formed and such section filling may increase the forming density of the molded body.

Here, uniformity of the interface between the different kinds of powders may be changed according to the ascending speed of the die 10. Since non-uniformity of the interface increases as the ascending speed of the die 10 increases, the ascending speed of the die 10 is minimized.

Further, mixing of the respective powders may be minimized by adjusting the ascending and descending speeds of the lower forming module 20 and the upper forming module 30, and the ascending and descending speeds of the lower forming module 20 and the upper forming module 30 are set to 0.2-1.8.

Further, a speed at which the respective powder suppliers A and B are transferred to the molded body formation area and then separated from the molded body formation is set to have a high value.

Further, reference numeral 21 indicates a core member of the lower forming module 20, which descends when the die 10 ascends.

The heterogeneous powder molded body of various embodiments of the present invention may be applied to various sintered bodies used as parts of vehicles.

That is, a sintered body formed of different kinds of powders in accordance with various embodiments of the present invention is manufactured by a forming machine including a die 10, a lower forming module 20 located under the die 10 so as to form a lower part of a molded body to be manufactured, and an upper forming module 30 located above the die 10 so as to form an upper part of the molded body to be manufactured.

In more detail, with reference to FIG. 2, a lower shape of the sintered body is formed by the lower forming module 20 of the forming machine to manufacture a heterogeneous powder molded body in accordance with various embodiments of the present invention.

Here, the sintered body in accordance with various embodiments of the present invention includes powder A processed parts 110 formed by inputting the powder A from the powder supplier A placed on the die 10.

Further, the sintered body in accordance with various embodiments of the present invention includes a powder B processed part 120 formed by inputting the powder B from the powder supplier B placed on the die 10.

Thereafter, the upper forming module 30 is pressurized in the downward direction and thus forms an upper shape of the sintered body formed of the powder A processed parts 110 and the powder B processed part 120.

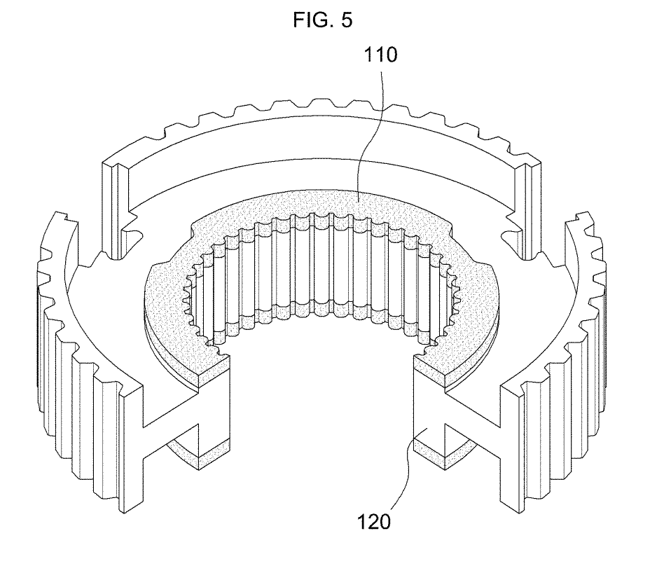

FIG. 5 is a view illustrating a synchronizer hub for vehicles including the above-described powder A processed parts 110 and powder B processed part 120. Here, the powder A processed parts 110 are formed in a core area of the center of the synchronizer hub (shown in red), and the powder B processed part 120 is formed in the remaining area of the synchronizer hub (shown in blue) other than the core area.

If the synchronizer hub, i.e., a sintered body in accordance with various embodiments of the present invention, is formed using different kinds of powders, conventional heat treatment may be omitted and thus quality degradation due to heat treatment may be prevented.

As is apparent from the above description, in a heterogeneous powder molded body and a manufacturing method thereof in accordance with various embodiments of the present invention, a product formed using different kinds of powders has no density gradient and good processability, reduces manufacturing costs and undergoes no quality degradation owing to omission of conventional heat treatment.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heterogeneous powder molded body comprising respective powder processed parts formed of different powders, the heterogeneous powder molded body being formed by a forming machine including a die, a lower forming module located under the die to form a lower part of a molded body to be manufactured, and an upper forming module located above the die to form an upper part of the molded body to be manufactured,
wherein, when each of the different powders is input onto the die to form the molded body, the die ascends and thus a filling time of each input powder is secured.

2. The heterogeneous powder molded body according to claim 1, wherein a filling ratio of the respective powders is adjusted to set strength and hardness of the respective powder processed parts to required degrees.

3. The heterogeneous powder molded body according to claim 1, wherein an ascending speed of the die is adjustable according to a required degree of uniformity of an interface between the respective powder processed parts.

4. The heterogeneous powder molded body according to claim 1, wherein ascending and descending speeds of the lower forming module and the upper forming module are adjustable.

5. The heterogeneous powder molded body according to claim 1, wherein speeds at which powder suppliers of the respective powders are transferred to and separated from the die are adjustable.

6. A manufacturing method of a heterogeneous powder molded body, formed of a first powder and a second powder, by a forming machine, having a die, a lower forming module located under the die to form a lower part of a molded body to be manufactured, and an upper forming module located above the die to form an upper part of the molded body to be manufactured, the manufacturing method comprising:
inputting the first powder from a first powder supply placed on the die to form a first powder processed part;
inputting the second powder from a second powder supply placed on the die to form a second powder processed part;
pressurizing the upper forming module in a downward direction to form an upper shape of the molded body formed of the first powder and the second powder; and
completing manufacture of the molded body by separating the upper forming module and the second forming module from the molded body.

7. The manufacturing method according to claim 6, further comprising, after the input of the second powder, re-inputting the first powder from the first powder supply again placed on the die to form another first powder processed part.

8. The manufacturing method according to claim 6, wherein, when each of the different powders is input onto the die to form the molded body, the die ascends and thus a filling time of the input powder is secured.

9. The manufacturing method according to claim 6, wherein a filling ratio of the respective powders is adjusted to set strength and hardness of the respective powder processed parts to required degrees.

10. The manufacturing method according to claim 8, wherein an ascending speed of the die is adjusted.

11. The manufacturing method according to claim 6, wherein ascending and descending speeds of the lower forming module and the upper forming module are adjusted.

12. The manufacturing method according to claim 6, wherein speeds at which the powder supplies of the respective powders are transferred to and separated from the die are adjusted.

13. A sintered body formed of different kinds of powders, manufactured by a forming machine including a die, a lower forming module located under the die to form a lower part of a molded body to be manufactured, and an upper forming module located above the die to form an upper part of the molded body to be manufactured, the sintered body comprising:
first powder processed parts formed by inputting a first powder from a first powder supply placed on the die; and
a second powder processed part formed by inputting second powder from a second powder supply placed on the die, wherein
a lower shape of the sintered body is formed by the lower forming module; and
an upper shape of the sintered body is formed by pressurizing the upper forming module in the downward direction.

14. The sintered body according to claim 13, wherein
the first powder processing parts are formed of mixture powder; and
the second powder processing part is formed of alloy powder.

15. The sintered body according to claim 14, wherein
the mixture powder used to form the first powder processing parts comprises Fe—Cu—C mixture powder; and
the alloy powder used to form the second powder processing part comprises Fe—Cr—Mo—C alloy powder.

16. The sintered body according to claim 13, wherein the sintered body is used as a synchronizer hub for vehicle.

17. The sintered body according to claim 16, wherein
the first powder processed parts are formed in a core area of a center of the synchronizer hub, and the second powder processed part is formed in a remaining area of the synchronizer hub other than the core area.
